(19) United States
(12) Patent Application Publication
(10) Pub. No.: US 2005/0245196 A1
(43) Pub. Date: Nov. 3, 2005

(54) Device and method for optimally estimating the transmission spectrum by means of the simultaneous modulation of complementary sequences

(76) Inventors: Vicente Diaz Fuente, Madrid (ES); Daniel Hernaniz Chiloeches, Madrid (ES); Jesus Berian Mugica, Madrid (ES)

Correspondence Address: GOTTLIEB RACKMAN & REISMAN PC, 270 MADISON AVENUE, 8TH FLOOR, NEW YORK, NY, 100160601, US

(21) Appl. No.: 10/835,843

(22) Filed: Apr. 29, 2004

(51) Int. Cl. H04B 10/08

(52) U.S. Cl. 455/67.11; 702/182

(57) ABSTRACT

A device and method for optimally estimating the transmission spectrum simultaneously modulates complementary sequences employing a signal transmitter, an encoder, a transmitter having a modulator; a convolver, an antenna, a receiver having a demodulator, and a decoder having an output filter. The device uses complementary sets of sequences, simultaneously transmitted to a physical means, the sum of autocorrelations of which corresponds to a Krönecker delta, allowing the extraction in reception of the spectral and temporal features of the means minimizing the effect of the noise.

### OBJECT OF THE INVENTION

The present specification refers to a patent application corresponding to a device and method for optimally estimating the transmission spectrum by means of the simultaneous modulation of complementary sequences, the purpose of which lies in being configured as a modulation and demodulation method, as well as the transmitter and receiver which allow estimating the temporal and frequential features of any transmission means.

### FIELD OF THE INVENTION

This invention is applicable within the telecommunications industry.

This invention is also applicable in the field of the spectrographic analysis of chemical compounds or of any compound or material at a distance, as well as the remote sensing of physical and chemical parameters.

### BACKGROUND OF THE INVENTION

Communication systems, spectral analysis, RADAR and SONAR systems transmit a signal which, reflected or not, reaches the receiver after crossing a transmission means.

This means behaves as a linear filter with a response to the impulse in H(ω) frequency or a temporal response h[n].

To make the process of recovery of the transmitted information possible, in the majority of communication systems it is essential to eliminate the effects produced by the transmission means to the transmitted signal s[n]. This process is known as equalization.

The frequency response can also be used to carry out a spectral analysis of the means and thus obtain information on the physical properties thereof.

The channel acts as a filter and distorts the signal. To this should be added noise, n[n], due to disturbances in the channel, thermal noise or other signals which interfere with those transmitted. In conclusion, the received signal, r[n], can be modeled as:
r[n]=s[n]* h[n]+n[n] (1)
where * denotes a convolution.

To eliminate the distortion introduced by the means to the signal, a filter is necessary with an impulse response f[n], such as:
r[n]* f[n]≈s[n] (2)

I.e., the received signal must be as similar as possible to that transmitted. This is never entirely fulfilled due to the fact that the noise, n[n), is not eliminated with the equalization, nor is the distortion completely eliminated.

In order to achieve the best possible equalization, it is necessary to know the means a priori.

I.e., it is essential to analyze the h[n] of the means in order to be able to counteract the effects of distortion.

Two methods for reaching this objective exist:
Static equalizers: their properties do not change over time.
Adaptive equalizers: they adapt to temporal variations of the distortion in the means.

The main drawback with the first ones is that they are more generic and do not solve the particular drawbacks of each situation.

Adaptive equalizers respond better to variations in the means, but their implementation is more complicated and they are very sensitive to noise.

Both for the first and for the second, the knowledge of the transmission means remains essential. The better this can be modeled, the greater precision will be achieved when restoring the transmitted signal.

The ideal method for the analysis of the means consists of transmitting a delta and analyzing what is received, i.e. obtaining the impulse response. At the digital level, this is achieved by transmitting a Krönecker delta, δ[n]:
s[n]=δ[n]
r[n]=h[n]+n[n] (3)

As can be seen, the received signal has information on the impulse response, h[n], contaminated with additive noise.

Based on the foregoing, it can be deduced that there is a necessity for a technique which allows, on the one hand, efficiently transmitting a Krönecker delta, and on the other hand, reducing the noise of the signal received. Sending a Krönecker delta directly is very complex, since this needs a high peak envelope power. With these two premises, a very precise model of the transmission means can be obtained.

The features drawn from the model of the means can also be used to equalize the latter in communications applications, or to analyze the physical features thereof, as is the case of discriminating between different types of objectives in SONAR and RADAR systems or carrying out spectral analyses to extract physicochemical properties, as is used in spectroscopy.

The existence of any patent or utility model having features which are the object of the present invention is not known.

### DESCRIPTION OF THE INVENTION

The device and method of optimal estimation of the transmission spectrum by means of the simultaneous modulation of complementary sequences object of the invention, uses M complementary sets of sequences.

By complementary, it is understood that the sum of their autocorrelations results in a Krönecker delta.

The value of M also coincides with the number of complementary sets of sequences which are orthogonal to one another.

By orthogonal, it is understood that the sum of the cross-correlations of the complementary sequences of each set is zero.

In the particular case of pairs (M=2) of orthogonal sequences, they receive the name of Golay sequences in honor of their discoverer. (These concepts are discussed in the article published by Tseng, C.-C. and Liu, C. L.: “Complementary Sets of Sequences”, in IEEE Trans. Inform. Theory, vol. IT-18, No. 5, pp. 644-652, September 1972.).

The explanation will be focused on the Golay sequences, since it is the simplest case, although the patent extends to any value for M.

The main property of the sequences used in this invention is that they have an ideal autocorrelation feature, i.e. it corresponds to a perfect Krönecker delta such that they comply with:

$${ϕ}_{11} [ n ] + {ϕ}_{22} [ n ] + … + {ϕ}_{MM} [ n ] = {\sum }_{i = 1}^{M} {ϕ}_{ii} [ n ] = \{ \begin{matrix}MN , & n = 0 \\ 0 , & n \neq 0\end{matrix} \qquad ( 4 )$$

where φᵢᵢ are the individual autocorrelations of each one of the chosen M complementary sequences of length N. Particularized for the case of Golay pairs of complementary sequences:

$${ϕ}_{II} [ n ] + {ϕ}_{QQ} [ n ] = \{ \begin{matrix}2 N , & n = 0 \\ 0 , & n \neq 0\end{matrix} \qquad ( 5 )$$

The generation of such sequences is carried out from the so-called basic 2, 10 and 26 bit kernels known to date (the rules for generating Golay sequences are discussed in the article entitled “Complementary Sequences” of M. J. E. Golay, published in IRE Transactions on Information Theory, vol. IT-7, pp. 82-87, April, 1961).

The system consists of two main blocks: an encoder and a decoder.

The encoding system is in charge of convoluting the digital signal to be transmitted with the corresponding complementary sequences.

The decoder, on the other hand, is in charge of correlating the received signals with the same complementary sequences which are used in the transmission, and adding up the results.

For the purpose of being able to work with signals theoretically, it is suitable to observe a block diagram of the process (FIG. 1).

As was introduced in the previous chapter, in order to estimate the channel a Krönecker delta of amplitude A is transmitted:
s[n]=Aδ[n] (6)

Let I[n] and Q[n] be the Golay complementary sequences of length N and amplitude A resulting from the convolution of the encoder with the Krönecker delta, let x_{I}[n] and x_{Q}[n] be the signals received and let h[n] be the transfer function which encompasses the transmission means, the transducer and the modulation system.

If we assume that the noises introduced by the receiver (thermal, interferences, etc.) are encompassed in a term n[n], the signal at the correlator input will be:

$${x}_{I} [ n ] = A {\sum }_{k = - ∞}^{∞} I [ n - k ] h [ k ] + n [ n ] \\ {x}_{Q} [ n ] = A {\sum }_{k = - ∞}^{∞} Q [ n - k ] h [ k ] + n [ n ] \qquad ( 7 )$$

The receiver output is the sum of the respective autocorrelations of each one of the signals: x_{I}[n] and x_{Q}[n] As this is an ergodic process, the result is equivalent to:

$$\begin{matrix}y [ n ] = ϕ {X}_{I} I [ n ] + ϕ {X}_{Q} Q [ n ] \\ = \frac{1}{N} {\sum }_{j = 0}^{N - 1} {x}_{I} [ j ] I [ j - n ] + \frac{1}{N} {\sum }_{j = 0}^{N - 1} {x}_{Q} [ j ] Q [ j - n ] \\ = {〈 {x}_{I} [ j ] I [ j - n ] 〉}_{N} + {〈 {x}_{Q} [ j ] Q [ j - n ] 〉}_{N}\end{matrix} \qquad ( 8 )$$

where

$${〈 x [ j ] 〉}_{N} = \frac{1}{N} {\sum }_{j = 0}^{N - 1} x [ j ]$$

is the temporal mean extended to N samples. Replacing,

$$y [ n ] = {〈 \{ A {\sum }_{k = - ∞}^{∞} I [ j - k ] h [ k ] + n [ j ] \} I [ j - n ] 〉}_{N} + {〈 \{ A {\sum }_{k = - ∞}^{∞} Q [ j - k ] h [ k ] + n [ n ] \} Q [ j + n ] 〉}_{N} \qquad ( 9 )$$

Grouping terms,

$$\begin{matrix}y [ n ] = A \{ {〈 {\sum }_{k = - ∞}^{∞} h [ k ] I [ j - k ] I [ j - n ] 〉}_{N} + \\ {〈 {\sum }_{k = - ∞}^{∞} h [ k ] Q [ j - k ] Q [ j - n ] 〉}_{N} \} + \\ {〈 n [ j ] I [ j - n ] 〉}_{N} + {〈 n [ j ] Q [ j - n ] 〉}_{N} \\ = A \{ {\sum }_{k = - ∞}^{∞} h [ k ] {〈 I [ j - k ] I [ j - n ] 〉}_{N} + \\ {\sum }_{k = - ∞}^{∞} h [ k ] {〈 Q [ j - k ] Q [ j - n ] 〉}_{N} + \\ {〈 n [ j ] I [ j - n ] 〉}_{N} + {〈 n [ j ] Q [ j - n ] 〉}_{N}\end{matrix} \qquad ( 10 )$$

Identifying terms and replacing,

$$\begin{matrix}y [ n ] = \frac{A}{N} {\sum }_{k = - ∞}^{∞} h [ k ] {ϕ}_{II} [ n - k ] + \frac{A}{N} {\sum }_{k = - ∞}^{∞} h [ k ] {ϕ}_{QQ} [ n - k ] + \\ \frac{1}{N} {\sum }_{j = 0}^{N - 1} n [ j ] I [ j - n ] + \frac{1}{N} {\sum }_{j = 0}^{N - 1} n [ j ] Q [ j - n ] \\ = \frac{A}{N} {\sum }_{k = - ∞}^{∞} h [ k ] \{ {ϕ}_{II} [ n - k ] + {ϕ}_{QQ} [ n - k ] \} + \\ \frac{1}{N} {\sum }_{j = 0}^{N - 1} n [ j ] \{ I [ j - n ] + Q [ j - n ] \}\end{matrix} \qquad ( 11 )$$

where φ_{II}[n] and Φ_{QQ}[n] are the autocorrelation functions of the pair of complementary sequences I[n] and Q[n] respectively, defined as:

$${ϕ}_{II} [ n ] = {\sum }_{k = 0}^{N - 1} I [ k + n ] I [ n ] \\ {ϕ}_{QQ} [ n ] = {\sum }_{k = 0}^{N - 1} Q [ k + n ] Q [ n ] \qquad ( 12 )$$

The main feature of equation (11) is that the terms of the autocorrelation functions have the same role as the functions of I[n] and Q[n] in expression (7), therefore the system response is not linked to the temporal response, but rather to the result of the autocorrelation functions. Furthermore, the noise term in the expression (11) is the cross-correlation of the noise function n[n] with I[n] and Q[n].

Applying the properties of the Golay complementary sequences shown in expression (5):
2Nδ[n]=φ_{II}[n]+φ_{QQ}[n] (13)

Replacing (13) in (11):

$$\begin{matrix}y [ n ] = 2 A {\sum }_{k = - ∞}^{∞} h [ k ] δ [ n - k ] + \frac{1}{N} ( {ϕ}_{nI} [ n ] + {ϕ}_{nQ} [ n ] ) \\ = 2 Ah [ n ] * δ [ n ] + \frac{1}{N} ( {ϕ}_{nI} [ n ] + {ϕ}_{nQ} [ n ] )\end{matrix} \qquad ( 14 )$$

where Φ_{nI}[n] and Φ_{nQ}[n] are the cross-correlations of the pair of complementary sequences I[n] y Q[n] with the noise n[n]. Operating,

$$\begin{matrix}y [ n ] = 2 A h [ n ] + \frac{1}{N} ( {ϕ}_{nI} [ n ] + {ϕ}_{nQ} [ n ] ) \\ = 2 A h [ n ] + \frac{1}{N} {\sum }_{j = 0}^{N - 1} n [ j ] \{ I [ j - n ] + Q [ j - n ] \}\end{matrix} \qquad ( 15 )$$

Knowing that the cross-correlation of two signals is the convolution with one of them being inverted:

$${ϕ}_{xy} [ n ] = {\sum }_{- ∞}^{+ ∞} x [ j ] y [ j - n ] = x [ n ] * y [ - n ] \qquad ( 16 )$$

The Fourier transform is:

$${ϕ}_{xy} [ n ] {⟶}^{F} X ( ω ) {Y}^{*} ( ω ) \qquad ( 17 )$$

The operator * indicates complex conjugation.

Applying the Fourier transform to expression (15):

$$Y ( ω ) = 2 AH ( ω ) + \frac{N ( ω )}{N} [ {I}^{*} ( ω ) + {Q}^{*} ( ω ) ] \qquad ( 18 )$$

In the previous expression, it can be appreciated that the result of the system is made up of the response to the impulse H(ω) of the transmission medium plus a noise term.

The main advantage of this method is found by analyzing the second term of expression (18).

Knowing that for a process with a nil mean, as is the case, the mean power is equal to zero autocorrelation:
σₓ²=φₓₓ[0] (19)

By calculating the mean power of expression (18), this can be written in the following manner:

$${σ}_{y}^{2} = {ϕ}_{xy} [ 0 ] = 4 {A}^{2} {ϕ}_{hh} [ 0 ] + \frac{{σ}_{n}^{2}}{{N}^{2}} [ {ϕ}_{II} [ 0 ] + {ϕ}_{QQ} [ 0 ] ] \qquad ( 20 )$$

By applying expressions (13) and (19), it results in a total mean power of:

$${σ}_{y}^{2} = 4 {A}^{2} {ϕ}_{hh} [ 0 ] + \frac{2 {σ}_{n}^{2}}{N} \qquad ( 21 )$$

Normalizing by a factor of ¼:

$${σ}_{y}^{2} = {A}^{2} {ϕ}_{hh} [ 0 ] + \frac{{σ}_{n}^{2}}{2 N} \qquad ( 22 )$$

where σ²ₙ is the noise power at the system input. This power is reduced by a factor of 2N.

The signal to noise ratio improves by a factor equal to two times the length of the sequence, since the noise power is reduced by a factor of 2N.

This can be translated into the following expression:
ΔN=2^{-Δ(S/N)/}3 (23)

In other words, if the length of the sequences is doubled, a noise reduction of 3 dB is obtained.

Inversely, to obtain a certain signal-noise ratio in dB, the length of the sequence must be increased according to expression (23).

In conclusion, it can be affirmed that the advantages of this technique are, on the one hand, being able to estimate the transfer function of the transmission means in an optimal manner, and on the other hand, reducing the noise effects according to N. Therefore, the invention being described constitutes a powerful system for estimating the transfer function of the means for use in equalization applications or simply for analyzing the frequential features or electromagnetic spectrum of a given means.

### DESCRIPTION OF THE DRAWINGS

To complement the description being carried out and for the purpose of helping to better understand the features of the invention, a set of drawings is attached to the present specification, as an integral part thereof, in which the following has been represented with an illustrative and non-limiting character:

FIG. 1 shows a block diagram of an estimation system of the means contemplated in the invention relating to a method for optimally estimating the transmission spectrum by means of simultaneous modulation of complementary sequences.

FIG. 2 shows the block diagram of a system explaining a possible application of the estimation of the means.

### PREFERRED EMBODIMENT OF THE INVENTION

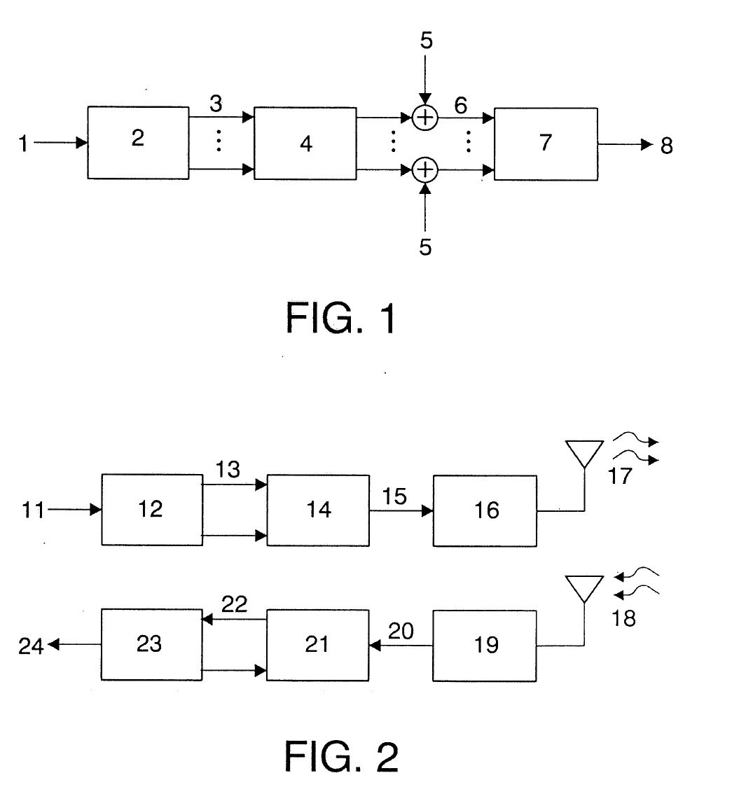

In view of FIG. 1, it can be observed how the device and method for optimally estimating the transmission spectrum by means of the simultaneous modulation of complementary sequences is constituted on the basis of a digital signal (1) for transmitting s[n], as well as an encoder (2) with complementary sequences, the result of convoluting the digital signal to be emitted with the N complementary sequences having been referenced with number (3), and when working with pairs of Golay complementary sequences, the 2 sequences are I[n] and Q[n], following the nomenclature of the previous apparatus.

The invention contemplates a transmission means (4) under h[n] analysis, this block including the necessary electronics for modulating/demodulating, the transducer or antenna and the physical transmission means, a noise (5) n[n] at the decoder input—which is the sum of all the different types of noises which affect the different steps of the system seen at the decoder input—, and signals (6) to the receiver input, having a decoder (7) —a filter which correlates the N received signals with the same complementary sequences which were used for the encoding and adds up the results and the result (8) of the process—.

Following FIG. 2, which shows the block diagram of a system explaining a possible application of the estimation of the means, the different parts composing it can be observed, which are detailed below:
a digital signal (11) to be transmitted s[n]: the ideal one for estimating the means is a Krönecker delta;
an encoder (12) with a pair of Golay complementary sequences;
signals (13) resulting from the I[n] and Q[n] encoding;
a QASK modulator (14) which modulates the I[n] signal in phase and which modulates the Q[n] signal in quadrature;
a signal (15) resulting from the QASK Tx[n] modulation;
a radio frequency modulator (16);
an antenna (17);
an antenna (18);
a radio frequency demodulator (19);
a signal (20) resulting from the radio frequency demodulation Rx[n];
a QASK demodulator (21), which gives r_{I}[n] and r_{Q}[n] as a result;
signals (22) resulting from the QASK rᵢ[n] and r_{Q}[n] demodulation;
a decoder (23) with a pair of Golay complementary sequences;
a signal (24) y[n] resulting from the process.
A possible implementation of this technique applied to the description of a physical means using a transmitter and a receiver of radio waves will now be detailed. For the sake of clarity, the implementation diagrammatically appears in FIG. 2.
This implementation, as has previously been stated, is based on the application of this method to radio frequency systems. In order to simplify the explanation, the particular case of QASK (‘Quadrature Amplitude Shift Keying’) modulated pairs of Golay complementary sequences has been taken. The system consists of two well differentiated blocks: the transmission system and the reception system.
The transmission system is in charge of:
Convoluting the input signal with each one of the two sequences forming the Golay pair of length N.
QASK modulating the two signals resulting from the encoding.
Modulating the QASK modulated signal for the transmission thereof in the corresponding area of the radioelectric spectrum.
Transmitting it with an antenna.
The reception system is in charge of:
Demodulating the signal received by the antenna.
Obtaining the components r₁[n], in phase, and r_{Q}[n], in quadrature, by means of the QASK demodulation.
Carrying out the decoding process by means of correlation sums, as has been shown in this document.
The resulting signal of the process contains the absorption spectrum H(ω) of the means through which the electromagnetic wave has been propagated in the bandwidth where applied, with a reduction of the thermal noise and the noise introduced by the different steps of the process proportional to the length N of the complementary sequences used.

1. A device for optimally estimating the transmission spectrum by means of the simultaneous modulation of complementary sequences, characterised essentially by being constituted of at least:
a signal transmitter;
an encoder (2);
a transmission means constituted by:
a modulator;
a convolver;
a transmitter or antenna;
a reception means preferably constituted of a demodulator;
a decoder (7) with an output filter;
and characterised equally by being based on the use of complementary sets of sequences, simultaneously transmitted to a physical means, the sum of autocorrelations of which corresponds to a Krönecker delta, allowing the extraction in reception of the spectral and temporal features of the means minimizing the effect of the noise.

2. A device for optimally estimating the transmission spectrum by means of the simultaneous modulation of complementary sequences, characterised by claim 1 wherein the signal transmitter allows the transmission of signals through a physical means, which comprises the generation of complementary sets of sequences, the principal features of which are:
the sum of the autocorrelations φᵢᵢ of the sequences forming the set is a Krönecker delta;
they have any length N;
they are transmitted using any symbol width, T, with any amplitude and with any level of oversampling.

3. A device for optimally estimating the transmission spectrum by means of the simultaneous modulation of complementary sequences, characterised by claim 1 wherein the complementary sequences are transmitted with the following features:
in parallel with other complementary sets of sequences, orthogonal or not to the previous ones, i.e. the sum of the cross-correlation is equal to zero for the orthogonal sequences;
they are transmitted simultaneously using a frequency modulation, phase or amplitude or a combination thereof.

4. A device for optimally estimating the transmission spectrum by means of the simultaneous modulation of complementary sequences, characterised by claim 1 wherein the complementary sequences are transmitted and received, after being propagated through the means, using any type of physical system which transforms the electromagnetic signal into a type of signal which can be transmitted by the means to be analyzed (transducer) or by antenna.

5. A device for optimally estimating the transmission spectrum by means of the simultaneous modulation of complementary sequences, characterised by claim 1 wherein the device allows the use thereof as a whole or in combinations for transmitting signals to a means with a view to obtaining the impulse response h[n] or the frequency response H(ω) thereof.

6. A method for optimally estimating the transmission spectrum by means of the simultaneous modulation of complementary sequences, comprising:
encoding of one or more Krönecker deltas with identical or with different amplitudes and any other temporal and frequential combination for the purpose of implementing the apparatus where the complementary sequences are transmitted and received after being propagated through the means;
the convolution, using any method, of the input signal with each one of the complementary sequences which make up the set;
the transmission of the signals resulting from the convolution;
the correlation or matched filtering, using any method, of the signals received at the decoder input with each one of the complementary sequences which make up the set used in the transmission;
the sum of the results of the resulting correlations for the obtainment of the features of the means.
